(19) United States
(12) Patent Application Publication
(10) Pub. No.: US 2008/0003505 A1
(43) Pub. Date: Jan. 3, 2008

(54) Electrical Hand-Held Power Tool

(76) Inventors: Steffen Wuensch, Holzgerlingen (DE); Wolfgang Hirschburger, Vereinigtes Koenigreich (GB)

Correspondence Address: MICHAEL J. STRIKER, 103 EAST NECK ROAD, HUNTINGTON, NY, 11743, US

(21) Appl. No.: 11/571,669

(22) PCT Filed: Dec. 12, 2005
(86) PCT No.: PCT/EP05/56685

§ 371 Date: Jan. 5, 2007

(30) Foreign Application Priority Data
Feb. 7, 2005 (DE) 102005005553.2

(51) Int. Cl. H01M 6/14

(52) U.S. Cl. 429/303

(57) ABSTRACT

An electrical hand-held power tool is provided, which includes at least one rechargeable battery (16). To attain a compact design of the hand-held power tool with small dimensions, the at least one rechargeable battery (16) is designed as a lithium-polymer rechargeable battery (16) made of metallized plastic foil and a gel-like polymer electrolyte, and is designed with a flat and/or bent and/or spherically curved shape as a single rechargeable element (17) and/or as a component (16′; 16″) composed of several rechargeable elements (17), and is adapted—in terms of dimensions and/or shape—to spaces—which accommodate the rechargeable elements (17)—in the machine housing (11) and/or handle (12) and/or a separate housing (27) which is attached or attachable to the machine housing (11) or handle (12) (FIG. 1).

### RELATED ART

The present invention is directed to an electrical hand-held power tool according to the definition of the species in claim 1.

Known electrical hand-held power tools in the power class from 2.4V to 3.6V, as made known, e.g., in EP 1 066 930, include a rechargeable battery composed of one or more NiCd cells as energy accumulators for the electric-motor drive of a working spindle which is connected with a tool. Commercially available NiCd cells are typically cylindrical or cubic in shape and are inserted in a concave rechargeable battery compartment provided at the rear end of the bar-shaped machine housing.

### ADVANTAGES OF THE INVENTION

The inventive electrical hand-held power tool with the features listed in claim 1 has the advantage, in terms of the rechargeable battery, of having a high energy density and a flexible shape—due to the metallized plastic foils which serve as the energy carrier—which makes it possible to store the lithium polymer rechargeable battery in the concave or empty spaces which already exist in the machine housing and/or handle and/or a separate housing which is attached or attachable to the machine housing, and which have very different three-dimensional shapes, in a manner that fills the concave or empty space in an optimal manner. It is therefore not necessary to provide special space for the rechargeable battery in the machine housing and/or handle and/or a separate housing which is attached or attachable to the machine housing or handle. Instead, the rechargeable battery can be inserted—entirely or in parts—in concave and empty spaces which exist anyway due to the design and which would otherwise go unused. This results in a compact design of the hand-held power tool, which improves handling and helps to reduce the packaging and shipping costs. In addition, a hand-held power tool designed for a cable connection can be easily converted to a hand-held power tool which is powered by a rechargeable battery without having to change the design of the machine housing and/or handle and/or a separate housing which is attached or attachable to the machine housing or handle in order to accommodate the rechargeable battery. Rechargeable elements for a lithium polymer rechargeable battery, which are referred to as standard cells, are commercially available in rectangular and round shapes with minimum thicknesses of 3 mm, and they can be molded into any shape desired by pressing them in shaping tools.

Due to the measures listed in the further claims, advantageous refinements and improvements of the electrical hand-held power tool described in claim 1 are made possible.

According to an advantageous embodiment of the present invention, the at least one lithium polymer rechargeable battery includes at least one rechargeable element designed as a strip, band, or plate, and which has a shape which is flat, bent, or curved spherically, e.g., in the manner of a spherical segment. The at least one rechargeable element or the several rechargeable elements which are combined to form the rechargeable battery are adapted—in terms of dimensions and/or shape—to the holding spaces in the machine housing and/or handle and/or a separate housing which is attached or attachable to the machine housing and/or the handle. The rechargeable elements of a lithium polymer rechargeable battery are electrically connected in parallel to ensure at least short-term availability of high supply currents for the electrical drive of the hand-held power tool. To obtain sufficiently high operating voltage, several lithium polymer rechargeable batteries which can have different configurations of cells or rechargeable elements are located such that they are distributed in the machine housing and/or handle and/or a separate housing which is attached or attachable to the machine housing or handle, and they are electrically connected in series.

According to an advantageous embodiment of the present invention, the lithium polymer rechargeable batteries are secured in the concave or empty spaces in the machine housing and/or handle and/or a separate housing which is attached or attachable to the machine housing or handle via clamping, staking, screwing, or Velcro connections, or they can be secured in the concave or empty spaces via bonding, casting, or the like.

According to alternative embodiments of the present invention, the inventive electrical hand-held power tool equipped with one or more lithium polymer rechargeable batteries is, e.g., a hand-held planer or a grinding machine, such as a finishing, eccentric, corner/detail or linear sander, or as a garden tool or a tacker or a jigsaw, a power tenon saw, a fretsaw, or a scraper. An aspect shared by all of these hand-held power tools is the fact that they do not require a high peak load from the rechargeable battery. The inventive electrical hand-held power tool equipped with lithium polymer rechargeable batteries can also be designed as a drill and impact drill, lightweight hammer, screwdriver, or the like. In a machine of this type, a torque-dependent clutch is preferably provided in the drive train as overload protection.

### DRAWING

The present invention is described in greater detail in the description below with reference to exemplary embodiments of an electrical hand-held power tool shown in the drawing.

FIG. 1 is a side view of an eccentric sander with the machine housing partially removed,

FIG. 2 is a side view of a finishing sander with one shell of a double-shelled machine housing removed,

FIG. 3 is a side view of a screwdriver with one shell of a double-shelled machine housing removed,

FIG. 4 is a sectional view along the line IV-IV in FIG. 3,

FIG. 5 is a side view of a jigsaw with one shell of a double-shelled machine housing removed,

FIG. 6 is a sectional view along the line VI-VI in FIG. 5,

FIG. 7 is a side view of a hand-held planer with one shell of the double-shelled machine housing removed,

FIG. 8 is a sectional view along the line VIII-VIII in FIG. 7,

FIG. 9 is a sectional view along the line IX-IX in FIG. 7,

FIG. 10 is a sectional view along the line X-X in FIG. 9.

### DESCRIPTION OF THE EXEMPLARY EMBODIMENTS

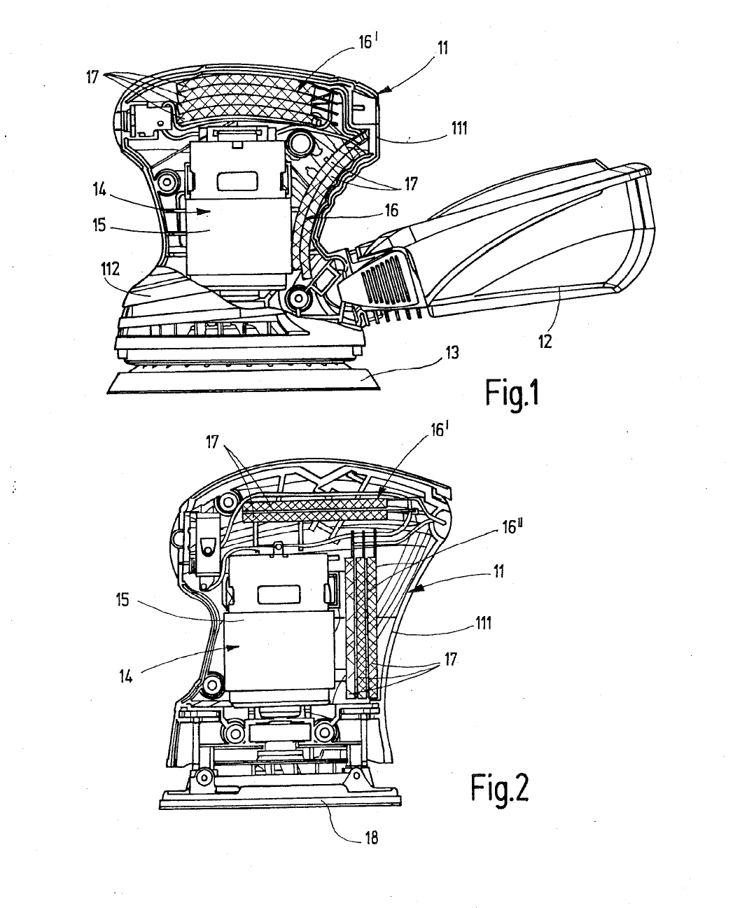

The electrical hand-held power tool designed as an eccentric sander in FIG. 1 includes a machine housing 11 and a handle 12 for handling and guiding the machine. Machine housing 11 is composed of two housing shells 111 and 112. In FIG. 1, front housing shell 112 is shown largely exposed so that the interior of machine housing 11 is visible. A sanding disk 13 which can be driven via eccentric gearing by an electric motor 14 is located on the lower end of machine housing 11. Electric motor 14 is accommodated in a motor housing 15 which is supported and secured in machine housing 11 between ribs formed on housing shells 111 and 112. Electric motor 14 obtains its electrical energy from at least one lithium polymer rechargeable battery 16. A lithium polymer rechargeable battery 16 of this type—referred to below as a lithium rechargeable 16—is composed of metallized plastic foils and a gel-like polymer electrolyte. Single lithium rechargeable 16 is composed of flat, rectangular or round rechargeable elements 17, which are available as “standard” cells in common commercial thicknesses of, e.g., 3 mm and up. Several of these rechargeable elements 17 can be electrically connected in parallel or in series, and they deliver current which is comparable to that of conventional NiCd rechargeable batteries. In the exemplary embodiment depicted in FIG. 1, several lithium rechargeables 16 are located in machine housing 11 as an example. One lithium rechargeable 16′ is located in the top part of machine housing 11, and one lithium rechargable 16″ is located in the side region of motor housing 15. Each of the two lithium rechargeables 16 is adapted—in terms of its dimensions and shape—to the space in which particular lithium rechargeable 16 is accommodated. Upper lithium rechargeable 16′ is composed of four stacked rechargeable elements 17 which are curved to match the contour of the upper housing wall. The dimensions of all four rechargeable elements 17 are identical. It is possible, however, to design uppermost rechargeable element 17 larger in size in order to fill the remaining space shown in the upper left region of machine housing 11 in FIG. 1. Lithium rechargeable 16″ located on the side in machine housing 11 is composed of two rechargeable elements 17 which are also arched or bent transversely to their longitudinal axis and have a curvature that enables outer rechargeable element 17 to rest flat against the side wall of machine housing 11. In both lithium rechargeables 16, rechargeable elements 17 are designed as rectangular plates which are curved transversely to their longitudinal axis. As an alternative, these rechargeable elements 17 can be designed as strips or bands.

The electrical hand-held power tool shown in a side view in FIG. 2 is designed as a finishing sander and also includes a double-shelled machine housing 11, front housing shell 112 of which is removed in FIG. 2, so that only rear housing shell 11 can be seen. Sanding disk 18 provided on lower end of machine housing 11 is drivable via a gearbox by an electric motor 14 in a back-and-forth swinging motion. Electric motor 14 is accommodated in a motor housing 15 which is secured in machine housing 11. Two lithium rechargeables 16 are provided for power supply, one lithium rechargeable 16′ of which is located in the top part of machine housing 11, horizontally, transversely to the motor axis, and lithium rechargeable 16 is located parallel to the motor axis, i.e., in a vertical position. Upper lithium rechargeable 16′ includes two rechargeable elements 17, and lithium rechargeable 16″ located on the side in machine housing 11 includes three rechargeable elements 17 which are connected in parallel. Every rechargeable element 17 is designed as a rectangular, flat plate. The plates are spaced apart and are combined to form one plate stack which is lithium rechargeable 16. The gap between individual rechargeable elements 17 or plates serves as an airflow space for the cooling air drawn in by the motor blower, thereby serving to cool lithium rechargeables 16.

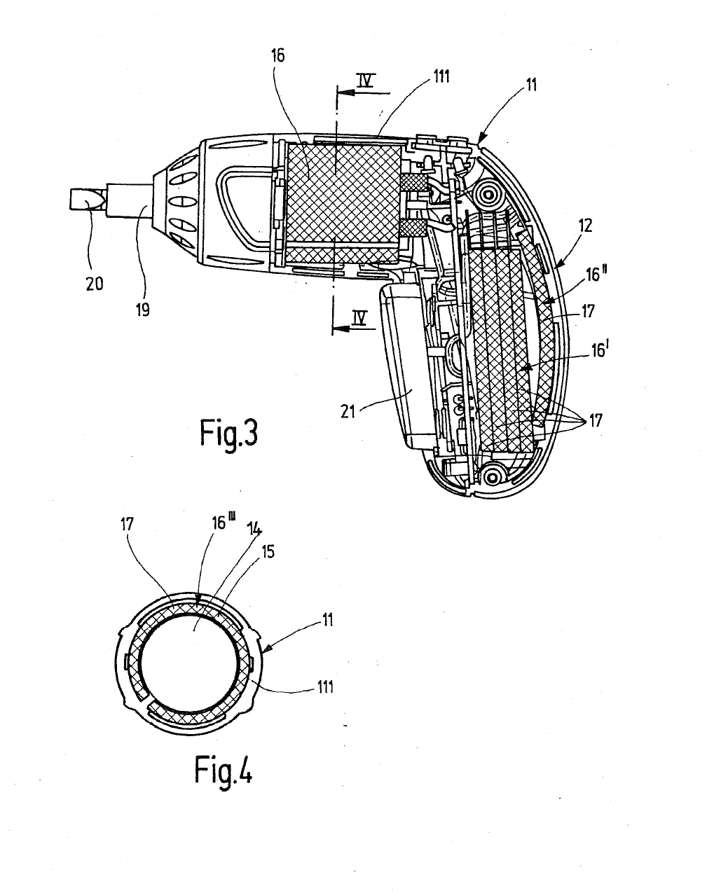

The electrical hand-held power tool shown in a side view in FIG. 3 is designed as a screwdriver and also includes a double-shelled machine housing 11 with which a pistol-shaped handle 12 is integrally molded. Only rear housing shell 111 of machine housing 11 is shown in FIG. 3. The screwdriver includes a working spindle 19 which is supported in machine housing 11 and on which a screwing tool 20 has been placed. Working spindle 19 is driven by an electric motor 14, of which only motor housing 15 is shown in FIG. 4, motor housing 15 being secured in machine housing 11 such that it is fixed in position axially and radially. Several lithium rechargeables 16 are provided to supply power. An on/off switch is located in the circuit between lithium rechargeables 16 and electric motor 14, which can be actuated using a control switch 21 located on handle 12. In the screwdriver, e.g., three lithium rechargeables 16′, 16″ and 16′″ which are electrically connected in series are distributed in machine housing 11 and pistol handle 12. Lithium rechargeable 16′ is composed of four parallel-connected, rechargeable elements 17 designed as a flat plate and combined to form a stack in which the plates are stacked directly on top of each other. Lithium rechargeable 16″ is formed by a single rechargeable element 17 which is designed as a curved plate, the curvature of which is matched to the inner contour of pistol handle 12. As an alternative, rechargeable element 17 which forms lithium rechargeable 16″ can be incorporated in rechargeable battery 16′ by connecting it electrically in parallel with the plate stack of lithium rechargeable 16′. In this case, only two, series-connected lithium rechargeables 16 are provided in the screwdriver. Third lithium rechargeable 16′″ is composed of a rechargeable element 17 which is bent in an annular shape, encloses motor housing 15 (FIG. 4), and is attached thereto. Instead of being fastened to motor housing 15, rechargeable element 17 which concentrically encloses motor housing 15 can also be fastened to machine housing 11. As an alternative, lithium rechargeable 16′″ can also be composed of several rechargeable elements 17 which are placed side by side in the circumferential direction of motor housing 15. Every rechargeable element 17 is therefore a shell segment which is bent around its longitudinal axis with a radius of curvature which corresponds to—or is slightly larger than—half of the outer diameter of motor housing 15. As an alternative, lithium rechargeable 16′″ can be designed as a tube or a band wound onto motor housing in the shape of a coil spring. With the tube design, it is advantageous to provide the outer and/or inner wall of the tube with a protective layer to protect it from mechanical damage and/or to provide it with a liner.

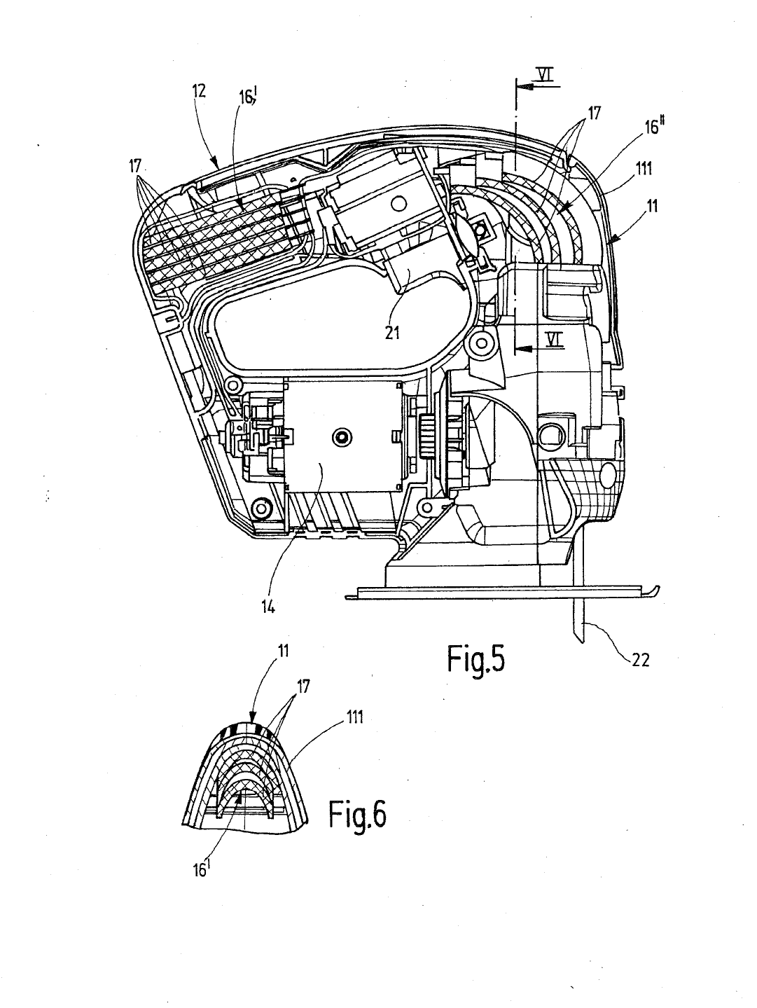

With the exemplary embodiment depicted in FIG. 5, the hand-held power tool is designed as a jigsaw. It also includes a double-shelled machine housing 11, of which only rear housing shell 111 and the interior of the machine can be seen in FIG. 5, after front housing shell has been removed. In machine housing 11, a handle 12 designed as a bracket is integrally molded with said machine housing, on the underside of which a control button 21 is located for turning an electric motor 14 on and off. Via a gearbox, electric motor 14 drives a lifting rod in a vertical reciprocating motion. A jigsaw blade 22 is clamped to the lower end of the lifting rod. The electrical energy for electric motor 14 is provided by two lithium rechargeables 16 which are distributed among different concave or empty spaces in machine housing 11 and are electrically connected in series. On/off switch 23 which can be actuated using control switch 21 is located in the connecting cables between lithium rechargeables 16 and electric motor 14.

One lithium rechargeable 16′ is located in bracket handle 12 and is composed of four rechargable elements 17. Rechargeable elements 17 are designed as rectangular, flat plates and are combined to form a plate stack with intermediate air gaps for air cooling. Individual rechargeable elements 17 are connected in parallel. Lithium rechargeable 16″ is located in the top front region of machine housing 11 above the lifting rod which carries jigsaw blade 22, and is composed of three parallel-connected rechargeable elements 17. Each rechargeable element 17 is formed by a spherically curved plate (FIG. 6). The spherical shape is adapted to the contour of machine housing 11 above the lifting rod.

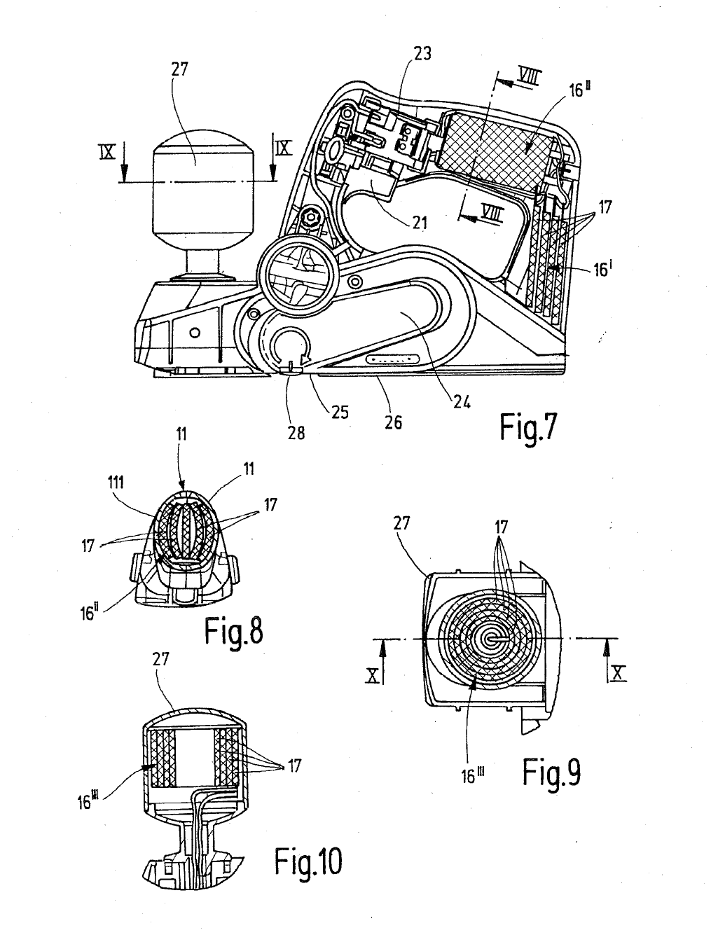

With the exemplary embodiment depicted in FIG. 7, the electrical hand-held power tool is designed as a hand-held planer. It includes a double-shelled machine housing 11 with a rear housing shell 111 and a front housing shell 112. A handle 12 designed as a bracket handle is formed in machine housing 11. A gearbox housing 24 which accommodates a planing tool 28 is mounted on front housing shell 112. Planing tool 28 extends out of a slot 25 in a base plate 26 located on the underside of machine housing 11 and extends more or less beyond base plate 26. The length of the extension of planing tool 28—which can be adjusted using an adjusting handle 27 mounted on machine housing 11—determines the planing depth. Adjusting handle 27 also serves as a guide handle for two-handed guidance of the hand-held planer during planing operation.

A not-shown electric motor is located in machine housing 11, which is electrically connectable via an on/off switch 23—which can be actuated using a control button 21 located on the underside of bracket handle 12—with an energy or power supply. Several lithium rechargeables 16 are provided as the power supply; they are located in empty or concave spaces in machine housing 11, in bracket handle 12, and in adjusting handle 27—which forms a separate housing—and they are electrically connected in series. A first lithium rechargeable 16′ is located in the rear—relative to the working direction—region of machine housing 11, and it is oriented vertically in the working position of the hand-held planer. It is composed of four parallel-connected rechargeable elements 17 which are designed as rectangular, flat plates and are combined to form a plate stack. Air gaps are provided between the individual plates in the plate stack, through which cooling air is directed. Second lithium rechargeable 16″″ is located in the bracket handle, in front—relative to the working direction—of on/off switch 23. As shown in the sectional view in FIG. 8, lithium rechargeable 16″ is composed of five rechargeable elements 17. Rechargeable elements 17 are connected in parallel and are designed as rectangular plates. The middle plate—which extends in the longitudinal axis of machine housing 11—is flat, while the plates located to the right and left of this middle plate are curved around their longitudinal axes. The two outer plates are adapted to the contour of bracket handle 12 and rest flat against the inner wall of bracket handle 12. As shown in the sectional views in FIGS. 9 and 10, third lithium rechargeable 16′″ is located in the concave interior of adjusting handle 27. Lithium rechargeable 16′″ is composed, e.g., of four hollow cylindrical rechargeable elements 17, which are positioned concentrically and bear against each other directly in the radial direction. Individual rechargeable elements 17 are connected in parallel. As an alternative, lithium rechargeable 16′″ can be designed as a spiral-wound strip or band.

Although not shown here, the lithium rechargeable can also be designed as part of the machine housing or as an element in the machine housing. For example, the lithium rechargeable can form a dust extractor connection which, in the case of grinding or sawing machines, serves to guide the dust into a dust collection container. The inside of the lithium rechargeable is preferably provided with a liner which facilitates the blowing-out of dust. The lithium rechargeable is simultaneously cooled by the exhaust air of the dust suction blower. In further embodiments, the lithium rechargeable can be designed as a cover or any other part of the machine housing and/or handle and/or a separate housing which is attached or attachable to the machine housing or handle, or it can be implemented in components of this type.

In all of the exemplary embodiments of the hand-held power tool described, lithium rechargeables 16 are immovably secured in the empty or concave spaces in machine housing 11 or in handle 12 or in adjusting handle 27 via, e.g., clamping, staking, screwing, Velcro connections, bonding, casting, or the like. Via the exemplary embodiments described in FIGS. 1 through 10, it is also possible to design the electrical hand-held power tool with lithium rechargeables 16 as corner/detail or linear sanders, as a garden tool, such as a grass edge trimmer, as a tacker, a scraper, a power tenon saw or fretsaw or the like, and lithium rechargeables 16 are adapted—in terms of dimensions and/or shape—to and are inserted in empty or concave spaces—which exist anyway due to the design and would otherwise go unused—in machine housing 11 and/or handle 12 and/or a separate housing which is attached or attachable to the machine housing or handle.

What is claimed is:

1. An electrical hand-held power tool with at least one rechargeable battery,
wherein
the at least one rechargeable battery is designed as a lithium polymer rechargeable battery (16) made of metallized plastic foils and a gel-like polymer electrolyte.

2. The hand-held power tool as recited in claim 1,
wherein
the dimensions and/or shape of the at least one lithium polymer rechargeable battery (16) are adapted, in at least one plane, to the spaces in the machine housing (11) and/or handle (12) and/or a separate housing (27) which is attached or attachable to the machine housing (11) or handle (12) which accommodate the lithium polymer rechargeable battery (16).

3. The hand-held power tool as recited in claim 1, wherein
the at least one lithium polymer rechargeable battery (16) includes at least one rechargeable element (17) designed as a strip, band, or plate, and has a shape which is flat, bent, or curved spherically, e.g., in the manner of a spherical segment.

4. The hand-held power tool as recited in claim 3,
wherein
the at least one lithium polymer rechargeable battery (16) is designed as a stack of plates which are preferably spaced apart and which have a shape which is flat, and/or bent, and/or curved spherically, and which are preferably connected electrically in parallel and/or in series.

5. The hand-held power tool as recited in claim 3,
wherein
the at least one lithium polymer rechargeable battery (16) is composed of several rechargeable elements (17) which are bent or curved spherically—either as a group or individually—and are preferably connected electrically in parallel and/or in series.

6. The hand-held power tool as recited in claim 1,
wherein
the at least one lithium polymer rechargeable battery (16) has a cylindrical, annular, or polygonal shape.

7. The hand-held power tool as recited in claim 1,
wherein
the at least one lithium polymer rechargeable battery (16) is designed as a band wound in the shape of a spiral or a helix, or it is designed as a tube.

8. The hand-held power tool as recited in claim 1,
wherein
the at least one lithium polymer rechargeable battery (16) is designed as part of the machine housing (11) and/or a handle (12) and/or a separate housing (27), e.g., as a dust extractor connection, a cover, or the like.

9. The hand-held power tool as recited in claim 1,
wherein
the at least one lithium polymer rechargeable battery (16) includes a protective layer on at least part of its surface, the protective layer being designed, e.g., as a mechanical protective jacket or a liner.

10. The hand-held power tool as recited in claim 1,
wherein
the at least one rechargeable battery (16) with a flat or bent or spherically curved shape is designed as a single rechargeable element (17) and/or in the form of at least one component—which is composed of several rechargeable elements (17)—in the machine housing (11) and/or handle (12), and/or a separate housing (27) which is attached or attachable to the machine housing (11) or handle (12), and/or it is located on a motor housing (15) inside the machine housing with its shape adapted to the particular holding spaces.

11. The hand-held power tool as recited in claim 1,
wherein
several lithium polymer rechargeable batteries (16) or individual rechargeable elements (17) thereof are distributed among individual open, concave, or empty spaces in the machine housing (11) or handle (12) and/or a separate housing (27) which is attached or attachable to the machine housing (11) or handle (12), and they are located therein and are adapted to the particular dimensions and/or shapes there.

12. The hand-held power tool as recited in claim 1,
wherein
the at least one lithium polymer rechargeable battery (16) is located in the cooling air flow.

13. The hand-held power tool as recited in claim 1,
wherein
the at least one lithium polymer rechargeable battery (16) is attached in a non-positive or form-fit manner.

14. The hand-held power tool as recited in claim 1,
wherein
the at least one lithium polymer rechargeable battery (16) is attached via clamping, staking, screwing, Velcro connections, or the like.

15. The hand-held power tool as recited in claim 1,
wherein
the at least one lithium polymer rechargeable battery (16) is attached via bonding, casting, or the like.

16. The hand-held power tool as recited in claim 1, characterized by its design as a hand-held planer, a grinding machine, such as a finishing, eccentric, corner/detail, or linear sander, as a garden tool, such as a grass edge trimmer, a tacker, a sawing machine, such as a jigsaw, a power tenon saw, a fretsaw, as a scraper, a drill or an impact drill, as a hammer, or a screwdriver.
